(19) United States
(12) Patent Application Publication
(10) Pub. No.: US 2005/0062192 A1
(43) Pub. Date: Mar. 24, 2005

(54) Method and apparatus for manufacturing mats

(76) Inventor: Chun-Ching Huang Tsai, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/667,434

(22) Filed: Sep. 23, 2003

(51) Int. Cl. B29C 59/04; B29C 61/00

(52) U.S. Cl. 264/160; 425/115; 425/304; 264/175; 264/259

(57) ABSTRACT

An apparatus for manufacturing mats includes first and second main rollers, applying rollers for applying first and second molten plastic materials over the first and the second main rollers, and scraping blades; each main roller has recess patterns on an outer side, and heating tubes and cooling water supplying pipes disposed therein; pressing rollers are respectively in contact with the first and the second main rollers for guiding leather between them and the main rollers; thus, a leather has plastic layers adhered to both sides thereof after passing the second main roller, which plastic layers have three dimensional patterns owing to the recess patterns of the main rollers; the blades scraping some plastic materials off the main rollers before the materials stick to the leather; the leather is cut into mats of desired shape afterwards, and colors of two sides can be changed according to the colors of the plastic materials.

### BACKGROUND OF THE INVENTION

1. Field of the Invention

The present invention relates to a method and apparatus for manufacturing mats, more particularly one for manufacturing plastic car mats and plastic floor mats having different colors and three-dimensional patterns on two sides.

2. Brief Description of the Prior Art

Referring to FIGS. 9, and 10, conventional mats can be made of transparent, semitransparent or nontransparent plastic materials, and are usually formed with anti-slip three-dimensions patterns on a lower side as well as an upper side thereof. Mats are made by means of conventional injection molding machines, which are relatively large in size, and can only manufacture single mat at a time. It is found that mat production by conventional injection molding machines has disadvantages as followings:
1. Most of such mats are at least 30 cm wide and 60 cm long therefore it takes large size injection molding machines to manufacture mats, which large size injection molding machines are relatively expensive, and will occupy large space in the factories. And, manufacturing cost of molds used with the molding machines is also very high. Consequently, it takes high cost to manufacture mats.
2. Injection molding machines can only manufacture one mat at a time therefore they are not efficient for manufacturing mats.
3. Molds to be used on injection molding machines are also very large in size. And, not only do such molds cost much money to manufacture, they also take much labor and time to install.
4. Most conventional mats are single color, and look monotonous because dual-color injection molding machines are even more expensive than single-color ones, and are seldom used for manufacturing mats.

### SUMMARY OF THE INVENTION

It is a main object of the present invention to provide a method and apparatus for manufacturing mats to overcome the above disadvantages.

The present apparatus includes first and second main rollers, a leather supplying mechanism for feeding leathers to the first and the second main rollers, front and rear material applying rollers for applying first and second molten plastic materials over the first and the second main rollers on rotation of the main rollers, and first and second scraping blades for smoothing the plastic materials applied over the main rollers. Each of the main rollers has recess patterns on an outer side, and heating tubes and water supplying pipes disposed therein. The leather supplying mechanism has a first pressing roller, which is in contact with the first main roller for guiding a first leather between it and the first main roller, and a second pressing roller, which is in contact with the second main roller for guiding the first leather between it and the second main roller. The front and the rear material applying rollers are respectively dipped in the plastic materials, and respectively in contact with the first and the second main rollers. A second leather can be passed between the second main and pressing rollers to stick to the first leather for increasing the thickness of the product. The products are cut into mats of desired shape afterwards. Thus, the mats can be dual-colors on two sides in case the first and the second plastic materials are different colors. Being mainly comprised of rollers, the present apparatus occupies less space, and is less expensive to manufacture than conventional molding machines and molds. And, the apparatus can manufacture several products at one time and continuously.

### BRIEF DESCRIPTION OF THE DRAWINGS

This invention will be better understood by referring to the accompanying drawings, wherein:

FIG. 1 is a side view of the apparatus for manufacturing mats according to the present invention,

FIG. 2 is a front view of the apparatus for manufacturing mats according to the present invention,

FIG. 3 is a partial view of the first shaping roller of the apparatus for manufacturing mats according to the present invention,

FIG. 4 is a partial view of the apparatus for manufacturing mats according to the present invention,

FIG. 5 is a partial side view of the apparatus for manufacturing mats according to the present invention,

FIG. 6 is a side view of a second embodiment of an apparatus for manufacturing mats,

FIG. 7 is a rear view of the apparatus for manufacturing mats according to the present invention,

FIG. 8 is a flow chart of the method for manufacturing mats according to the present invention,

FIG. 9 is a perspective view of a conventional mat, and

FIG. 10 is a partial front view of the conventional mat.

### DETAILED DESCRIPTION OF THE PREFERRED EMBODIMENTS

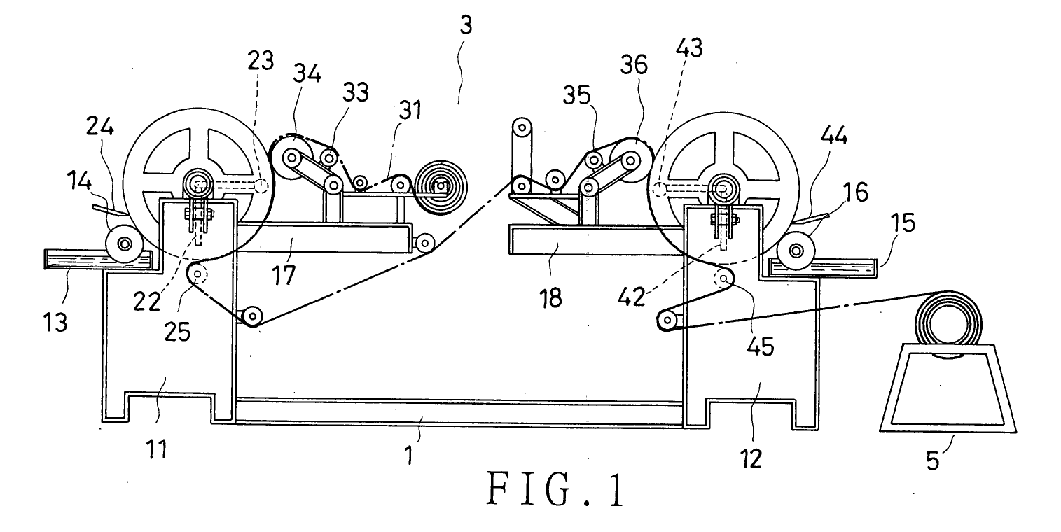

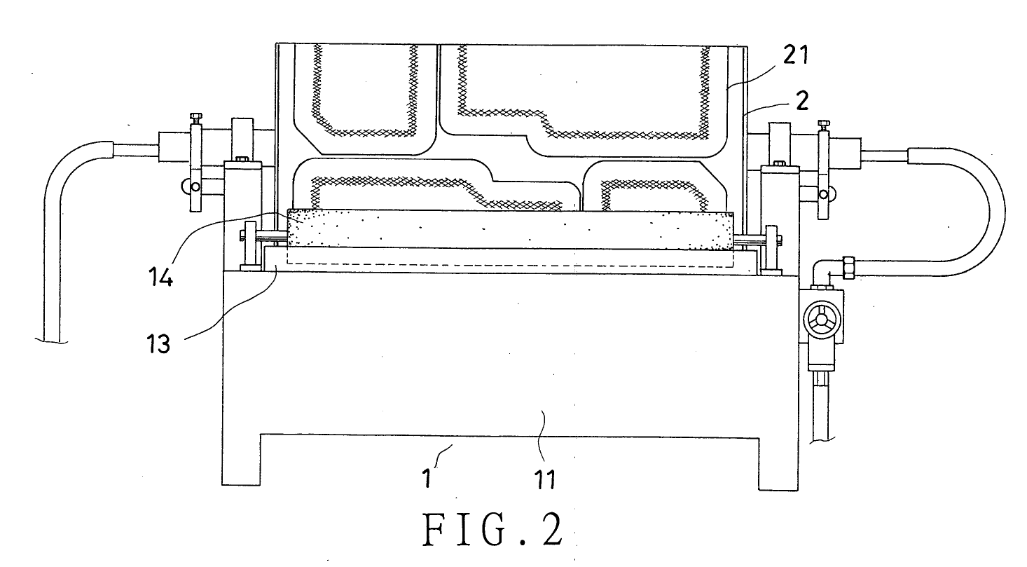

Referring to FIG. 1, a first embodiment of an apparatus for manufacturing mats in the present invention includes a main base 1, a first main roller 2, a leather supplying mechanism 3, and a second main roller 4.

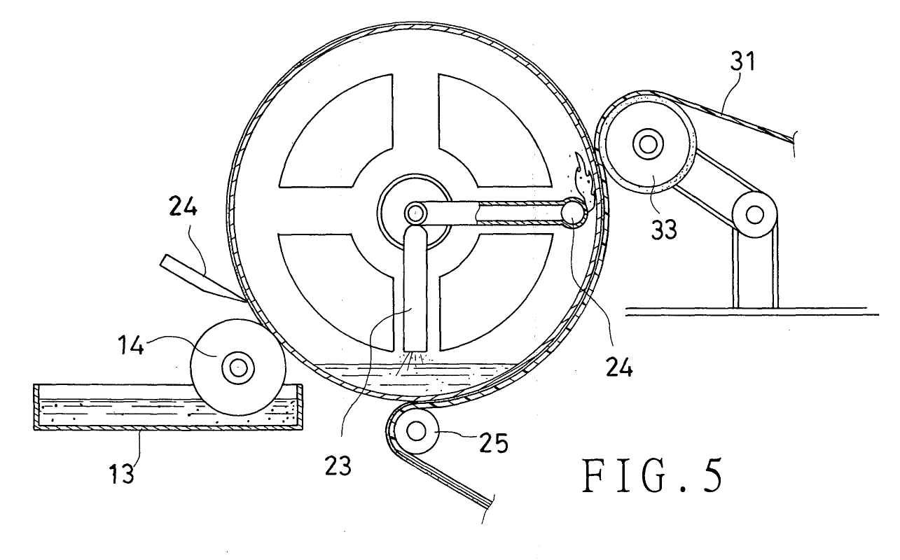

The main base 1 has front and rear parts 11, 12, on which the first and the second main rollers 1, 2 are respectively supported. There are front and rear material containers 13, 15 respectively disposed on the front part 11 and the rear part 12 of the main base 1 for holding first and second liquid materials therein. Fist and second material applying rollers 14, 16 are respectively dipped in the first and the second liquid materials, and respectively in contact with the first and the second main rollers 2, 4, as shown in FIGS. 1 and 5. There are first and second support elements 17, 18 arranged between the front and the rear parts 11, 12 of the main base 1.

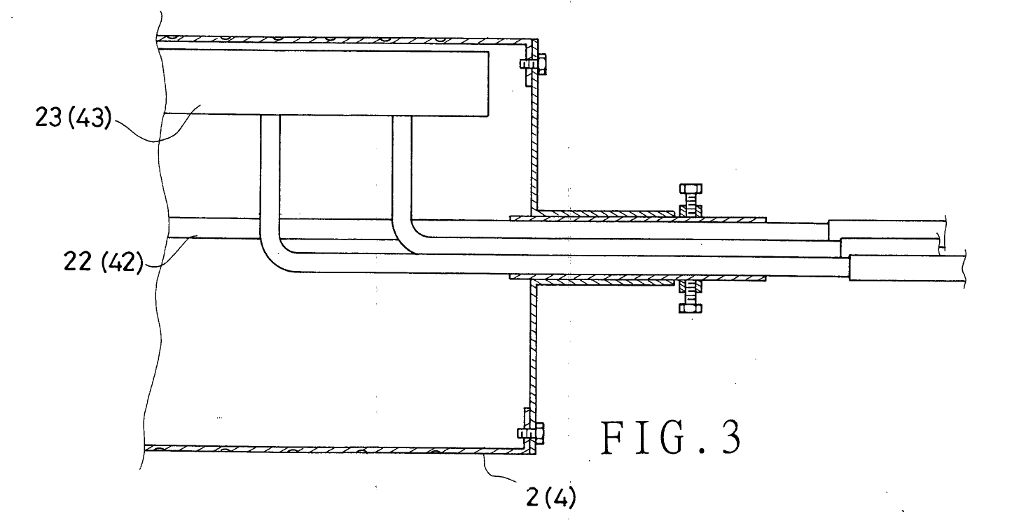

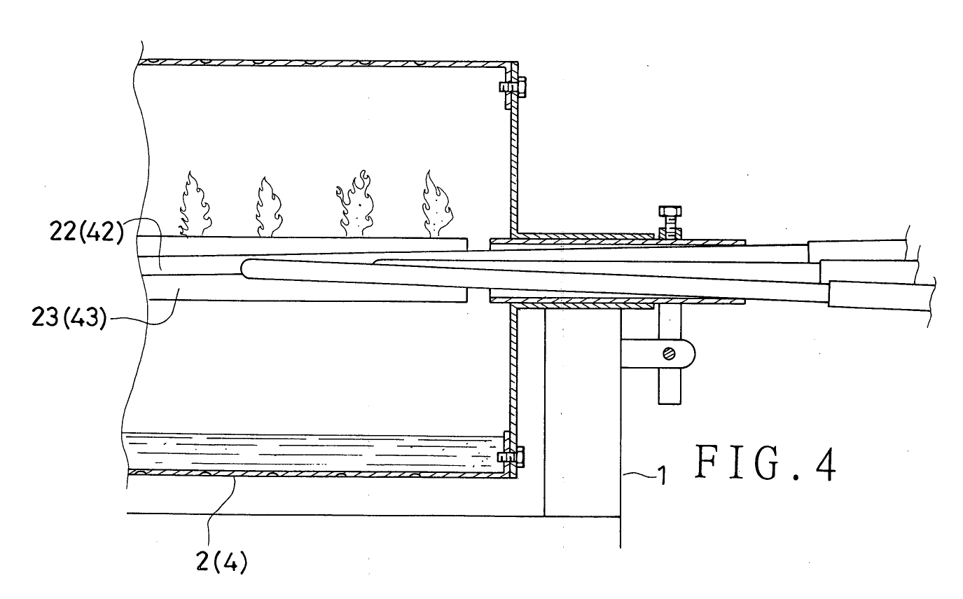

The first main roller 2 is formed with recess patterns 21 on an outer surface by means of etching. There are water supplying pipes 22, and heating tubes 23 disposed in the first main roller 2 for supplying cooling water to the roller 2, and for heating the roller 2 respectively, as shown in FIGS. 3 and 4; gas can be used with the heating tubes 23 as the fuels. A scraping blade 24 is disposed next to the roller 14 and close to the first main roller 2 such that when the first main roller 2 is turned, and first liquid material is applied thereon via the roller 14, some liquid material is scraped off the roller 2 by the blade 24, and liquid material left on the roller 2 becomes smooth. A subsidiary roller 25 is arranged near to a lower side of the first main roller 2.

Similarly, the second main roller 4 is formed with recess patterns 41 on an outer surface by means of etching. There are water supplying pipes 42, and heating tubes 43 disposed in the second main roller 4 for supplying cooling water to the roller 4, and for heating the roller 4 respectively, as shown in FIGS. 3 and 4. A scraping blade 44 is disposed next to the roller 16 and close to the roller 4 such that when the roller 4 is in operation for second liquid material to be applied thereon via the roller 16, some second liquid material is scraped off the roller 4 by the blade 44, and second liquid material left on the roller 4 becomes smooth. A subsidiary roller 45 is arranged near to a lower side of the first main roller 4. Furthermore, there are a pressing roller 36 arranged close to the second main roller 4 as well as the heating tubes 43, and a subsidiary roller 35 arranged apart from the pressing roller 36.

The leather feeding mechanism 3 is disposed on the first support element 17 for feeding a first leather 31 to the first main roller 2. There is a pressing roller 34 arranged close to the first main roller 2 for pressing leather against the roller 2, and close to the heating tubes 23. And, there is a subsidiary roller 33 arranged apart from the pressing roller 34. The first leather 31 is passed over the roller 33, and then passed and pressed between the pressing roller 34 and the first main roller 2 so that the leather 31 sticks on first liquid material applied over the roller 2 when the roller 2 is in operation. Furthermore, the leather 31 is passed between the subsidiary roller 25 and the first main roller 2 after passing the pressing roller 34, and is then guided in a substantially opposite direction so that it can be separated from the roller 2 after passing the subsidiary roller 25. The leather 31 will pass the heating tubes 23 after the material has stuck on it so that the heat from the heating tubes make the first liquid material even more firmly adhered to the first leather 31. The water pipe 22 supplies cooling water to the roller 2, which cooling water will stay in the lower portion of inside of the roller 2, and cool the first liquid material adhered to the first leather 31 when the first leather 31 is passing between the roller 25 and the lower side of the roller 2.

Thus, the layer of first material, which has been adhered to the first leather 31, is separated from the roller 2 together with the leather 31, and has three-dimensional patterns formed thereon owing to the recess patterns 21 on the roller 2. The first leather 31 is passed over the subsidiary roller 35, and then passed and pressed between the pressing roller 36 and the second main roller 4 after having passed the roller 25 under the first main roller 2; thus, when the first and the second main rollers 2 and 4 is in operation, the second liquid material is adhered to the other side, i.e. lower side, of the first leather 31 in the same way as the first liquid material being adhered to the upper side of the leather 31. The first leather 31 is passed between the roller 4 and the subsidiary roller 45, and then guided in a substantially opposite direction so that it can be separated from the roller 4 after passing the subsidiary roller 45. The first leather 31 is wound around the reel 5 after passing the roller 45, and will be cut into separate mats of predetermined size and shape by means of pressing a cutting knife (not shown) against a bench (not shown), on which the leather 31 is positioned, afterwards.

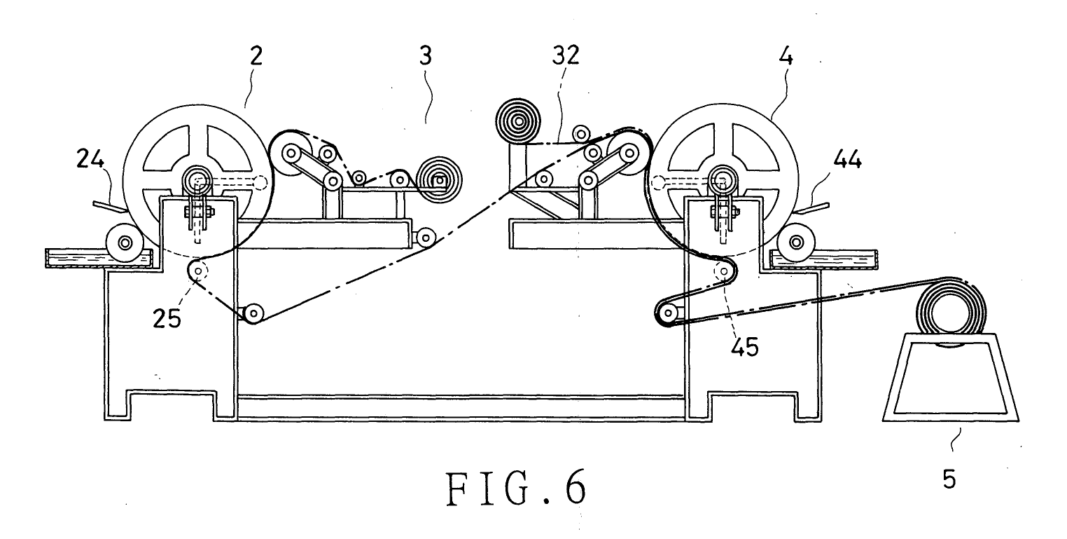

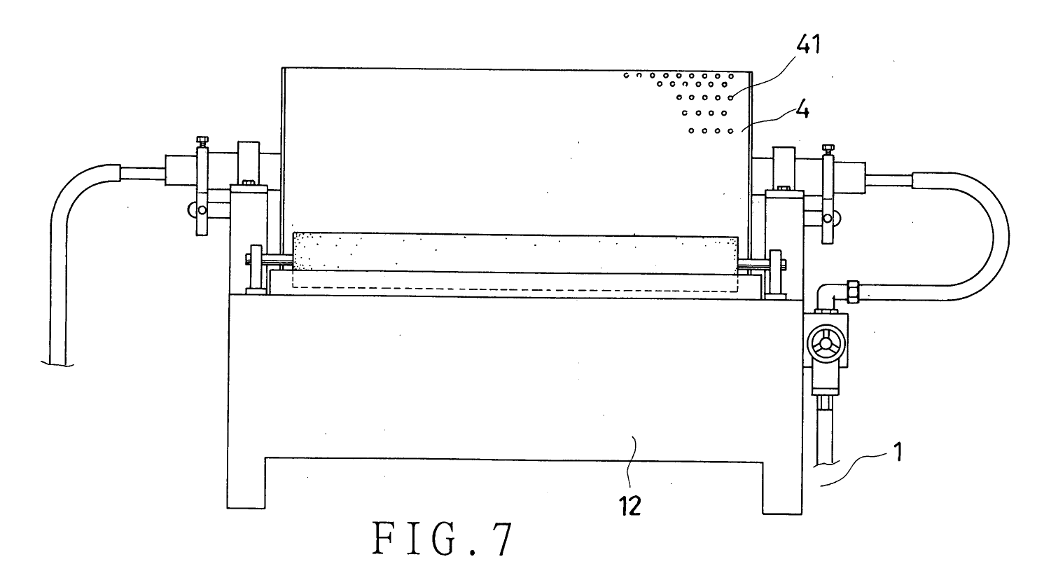

A second leather 32 will be supported on the second support element 18, and passed and pressed between the second main roller 4 and the pressing roller 36 together with the first leather 31 in case the first leather 31 isn't thick enough, as shown in FIG. 6. Thus, when the rollers 2 and 4 are in operation, the first and the second leathers 31 and 32 will stick to each other while the second liquid material will be adhered to the second leather 32 instead, and the leathers 31 and 32 sticking to each other can be cut into mats with enough thickness afterwards.

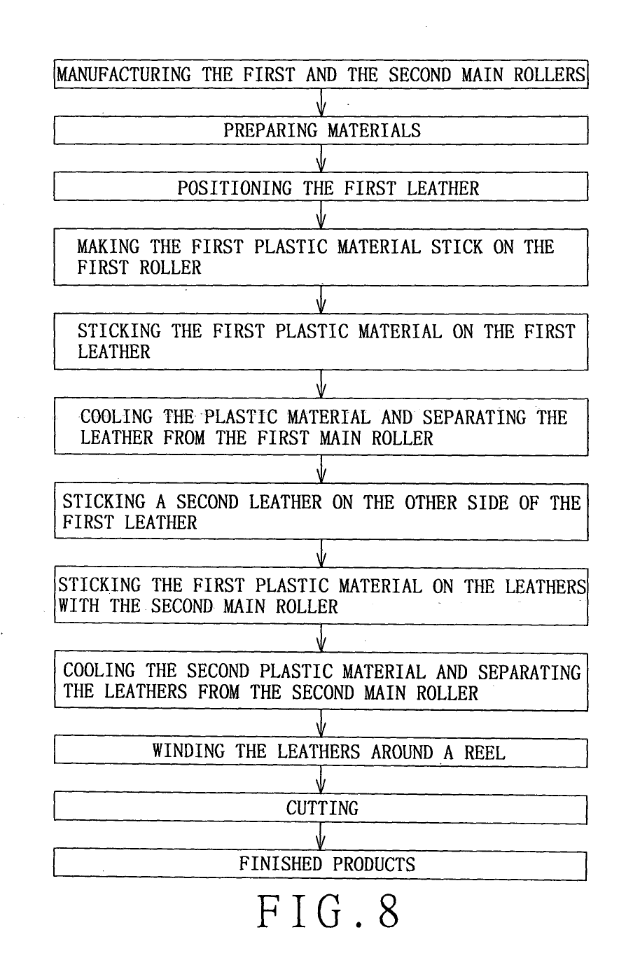

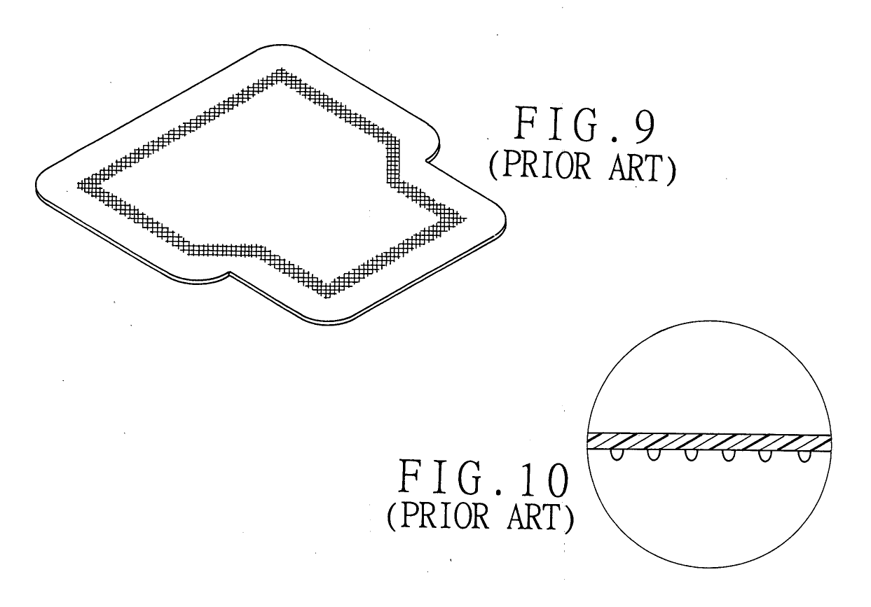

From the above description, it can be seen that the method for manufacturing mats in the present invention includes, as shown in FIG. 8, the steps of:
1. manufacturing the first and the second main rollers 2 and 4; the rollers 2, 4 are formed with recess patterns 21, 41 for respective sides of a product to be accordingly formed with three-dimensional patterns;
2. preparing materials; first and second plastic materials 13, and 14 are separately stirred and molten, and respectively held in the front and the rear containers 13, 15; PVC powder can be used as the materials;
3. positioning a first leather 31; the first leather 31 is positioned on the feeding mechanism 3, and passed over the roller 33, passed and pressed between the first main roller 2 and the pressing roller 34;
4. effecting rotation of the first roller 2 to make the first molten material stick on the roller 2; the material applying roller 14 will turn together with the roller 2 so as to apply the first plastic material over the roller 2 and into the recess patterns 21, and the first scraping blade 24 will scrape some of the first plastic material off the roller 2 to make the first material smooth;
5. sticking the first plastic material on the first leather 31; a layer of first plastic material is stuck to the leather 31 between the rollers 2 and 34 owing to the rotation of the roller 2, and the heating tubes 23 produce heat to make the plastic material firmly adhered to the leather 31;
6. cooling the plastic material and separating the leather 31 from the main roller 2; cooling water is supplied inside the roller 4 by the water pipes 22 so that the layer of first plastic material is cooled after having been heated and adhered to the leather 31; the leather 31 is passed between the rollers 2 and 25, and guided in a substantially opposite direction so that it can be moved along, and can be separated from the roller 2 together with the layer of first plastic material; the first leather 31 is passed between the rollers 36 and the second main roller 4 after separating from the roller 2;
7. sticking a second leather 32 on the other side of the first leather 31 in case the first leather 31 isn't thick enough; the second leather 32 is supported on the second support 18, and passed between the rollers 36 and the second main roller 4 together with the first leather 31;
8. adhering a second plastic material to the other side of the first leather 31 in case the second leather 32 is not used, or adhering the second plastic material to an outward side of the second leather 32 in case the second leather 32 is adhered to the first leather 31; a layer of second plastic material is stuck to the leather on rotation of the roller 4, and the heating tubes 43 produce heat to make the second plastic material firmly adhered to the leather; the rotation of the roller 4 making the applying roller 16 turn while being dipped in the plastic material, and making he scraping blade 44 scrape some second plastic material off the leather;
9. cooling the second plastic material and separating the leather from the main roller 4; cooling water is supplied inside the roller 4 by the water pipes 42 so that the layer of second plastic material is cooled after having been heated and adhered to the leather; the leather is passed between the rollers 4 and 45, and is further passed over the roller 45;
10. winding the leather around the reel 5; the leather is wound around the reel 5 after having been separated from the roller 4 together with the layer of second plastic material;
11. cutting the leather into mats; the leather with the plastic layers on both sides are cut into separate mats of desired size and shape by means of cutting mechanisms.

From the above description, it can be understood that as compared with the conventional method as described in the Background, the present invention has advantages as followings:
1. The present apparatus can manufacture mats continuously, and is less complicated in structure, easier to use and maintain, and cheaper to manufacture than the conventional injection molding machine because it is mainly comprised of various rollers.
2. The present apparatus is more efficient because it can manufacture mats continuously. Consequently, the manufacturing cost of the products decreases.
3. It is easier and cheaper to form recess patterns on rollers than to manufacture large-size molds. And, when longer rollers are used, the width of leather to be adhered to plastic materials can be accordingly increased, and in turns, productivity can be increased.
4. To change the thickness of products, the manufacturers only have to use a leather of different thickness instead or stick another leather to the original one accordingly the present invention while a new mold has to be prepared in case a conventional injection molding machine is used as the manufacturing apparatus.
5. In case the first and the second plastic materials are different colors, the leather will be different colors on two sides. Therefore, it is relatively easy to manufacture mats having two sides of different colors, which will be more competitive.
6. According to the present invention, manufacturers can easily substitute different color plastic materials for the original ones for changing the colors of products while to change the colors of products, they will have to wait four to five hours for the material feeding tube to cool in case a conventional molding machine is used.

1. An apparatus for manufacturing mats, comprising
a main base having front and rear parts, and first and second support elements between the front and the rear parts thereof; the front and the rear parts respectively having front and rear material containers disposed thereon;
a first main roller turnably arranged on the front part of the main base; the first main roller having recess patterns on an outer side, and having heating tubes and water supplying pipes disposed therein;
a second main roller turnably arranged on the rear part of the main base; the second main roller having recess patterns on an outer side, and having heating tubes and water supplying pipes disposed therein;
a leather supplying mechanism for feeding leathers to the first and the second main rollers; the leather supplying mechanism being supported by the first and the second support elements; the leather supplying mechanism having first pressing roller, which is in contact with the first main roller for guiding a leather between it and the first main roller with one side of the leather opposing the first main roller; the leather supplying mechanism having a second pressing roller, which is in contact with the second main roller for guiding the leather between it and the second main roller with other side of the leather opposing the second main roller; the leather supplying mechanism having subsidiary rollers for guiding leathers to the first and the second pressing rollers respectively;
front and rear material applying rollers respectively dipped in liquid materials in the front and the rear material containers, and respectively in contact with the first and the second main rollers for applying the liquid materials over the first and the second main rollers on rotation of the main rollers; and
first and second scraping blades respectively disposed close to the first and the second main rollers for scraping outer sides of the liquid materials off the main rollers before the liquid materials stick to the leather.

2. A method for manufacturing mats, comprising the steps of:
(1) manufacturing first and second main rollers; the main rollers being formed with recess patterns on outer sides;
(2) preparing materials; first and second plastic materials being separately stirred and molten, and respectively held in front and rear containers;
(3) positioning a first leather; the first leather being positioned on a feeding mechanism, and guided by first subsidiary rollers, and being passed and pressed between a first main roller and a first pressing roller;
(4) effecting rotation of the first main roller to make the first plastic material stick on the first main roller; a first material applying roller, which is dipped in the first molten plastic material and is in contact with the first main roller, turning together with the first main roller to apply the first plastic material over a surface and into the recess patterns of the first main roller on rotation of the main roller; a first scraping blade, which is disposed close to the first main roller, scraping some of the first plastic material off the first main roller on rotation of the main roller;
(5) sticking the first plastic material on the first leather; a layer of first plastic material over the main roller sticking to one side of the first leather on rotation of the first main roller; first heating tubes, which are disposed in the first main roller, producing heat to make the first plastic material adhered to the first leather;
(6) cooling the plastic material and separating the first leather from the first main roller; first water pipes, which are disposed in the first main roller, supplying cooling water into the main roller for cooling the layer of first plastic material; then, the first leather being passed between the first main roller and a second subsidiary roller, and guided in a substantially opposite direction such that it is separated from the first main roller together with the layer of first plastic material;
(7) adhering a second plastic material to other side of the first leather; a second material applying roller, which is dipped in the second molten plastic material and is in contact with the second main roller, turning together with the second main roller to apply the second plastic material over a surface and into the recess patterns of the second main roller on rotation of the second main roller; a second scraping blade, which is disposed close to the second main roller, scraping some of the second plastic material off the second main roller on rotation of the main roller; the first leather being passed and pressed between the second main roller and a second pressing roller for a layer of second plastic material to stick to other side thereof on rotation of the second main roller; second heating tubes producing heat to make the second plastic material adhered to the first leather;
(8) cooling the second plastic material and separating the first leather from the second main roller; cooling water being supplied in the second main roller by second water pipes so that the layer of second plastic material is cooled; the first leather being passed between the second main roller and a third subsidiary roller, and guided in a substantially opposite direction such that it is separated from the second main roller together with the layer of second plastic material;
(9) storing the first leather; the leather is wound around a reel; and
(10) cutting the first leather into mats; the leather with the first and the second plastic layers on both sides being cut into separate mats.

3. The method for manufacturing mats as claimed in claim 2 further comprising a step of sticking a second leather on said other side of the first leather in case the first leather isn't thick enough; the second leather being supported on a second support, and passed between the second main roller and the second pressing roller together with the first leather to stick to said other side of the first leather.
